(19) United States
(12) Patent Application Publication
(10) Pub. No.: US 2008/0167099 A1
(43) Pub. Date: Jul. 10, 2008

(54) Skin having enameled metal structure for mobile device

(75) Inventor: Heng-Yen Liu, Jhudong Township (TW)

Correspondence Address: TROXELL LAW OFFICE PLLC, Suite 1404, 5205 Leesburg Pike, Falls Church, VA, 22041, US

(73) Assignee: Hocheng Corporation

(21) Appl. No.: 11/716,660

(22) Filed: Mar. 12, 2007

(30) Foreign Application Priority Data
Jan. 4, 2007 (TW) 096200170

(51) Int. Cl. H04M 1/00

(52) U.S. Cl. 455/575.8; 379/451

(57) ABSTRACT

A mobile device has a skin with an enameled metal structure. With the skin, the surface of the mobile device is prevented from scrape and corrosion with ease of cleaning. Moreover, China-chic beauty and feel are obtained with the skin, which is contrasting to a normal appearance of a common mobile device.

### FIELD OF THE INVENTION

The present invention relates to a skin; more particularly, relates to a mobile device skin prevented from scrape and corrosion with a good heat conductivity for required operation performance and with China-chic beauty and feel with ease of cleaning.

### DESCRIPTION OF THE RELATED ARTS

Surfaces of mobile devices are usually made of plastics, engineering plastics (like acrylonitrile-butadine-styrene (ABS) polycarbonate (PC), etc.), or metal alloys (like aluminum-magnesium alloy, titanium alloy, etc.) The engineering plastics have good plasticity for fabricating objects with complex shapes; yet have heavy weights and usually bad heat conductivities. Although the PC has good plasticity as well as a good heat conductivity, it is easily broken when being dropped down. And the metal alloys have good heat conductivities and better hardness with lighter weights than the engineering plastics; yet have higher production costs and lower yield rates owing to pores formed during fabricating processes. All these materials for the mobile device skins may easily broken, scraped, corroded and dirtied. In addition, the surfaces made of these materials are so monotonous in color, even pasted with trade marks or printed with some graphics, that they are still bad looking and rough in design without uniqueness.

Hence, there is a prior art, called “A skin with fiber lines for communication device”, comprising a communication device with an embedding are a on a surface; and a fiber-knitted skin embedded in the embedding are a with a size fitted to the embedding are a. Although the prior art may to some extent overcomes the disadvantages of the general mobile device skins, the prior art is still apt to be broken, scraped or corroded without China-chic beauty. Hence, the prior arts do not fulfill users' requests on actual use.

### SUMMARY OF THE INVENTION

The ma in purpose of the present invention is to prevent a mobile device skin from scrape and corrosion with a good heat conductivity for required operation performance and with ease of cleaning.

Another purpose of the present invention is to obtain China-chic beauty and feel.

To achieve the above purposes, the present invention is a skin having an enameled metal structure for a mobile device, comprising a metal base layer, an image are a on a surface of the metal base layer, and a coating layer on the metal base layer and the image area; or, comprising a shell, and an image unit comprising a metal base layer, an image area and a coating layer, where a mobile device skin is prevented from scrape and corrosion; the mobile device has a good heat conductivity for required operation performance; and China-chic beauty and feel are obtained with ease of cleaning. Accordingly, a novel skin having an enameled metal structure for a mobile device is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present invention;

FIG. 2 is the explosive view showing the first preferred embodiment;

FIG. 3 is the sectional view showing the first preferred embodiment;

FIG. 4 is the perspective view showing the second preferred embodiment;

FIG. 5 is the perspective view showing the third preferred embodiment;

FIG. 6 is the perspective view showing the fourth preferred embodiment;

FIG. 7 is the explosive view showing the fourth preferred embodiment;

FIG. 8 is the sectional view showing the fourth preferred embodiment;

FIG. 9 is the perspective view showing the fifth preferred embodiment;

FIG. 10 is the perspective view showing the sixth preferred embodiment;

FIG. 11 is the explosive view showing the seventh preferred embodiment; and

FIG. 12 is the sectional view showing the seventh preferred embodiment.

### DESCRIPTIONS OF THE PREFERRED EMBODIMENTS

The following descriptions of the preferred embodiments are provided to understand the features and the structures of the present invention.

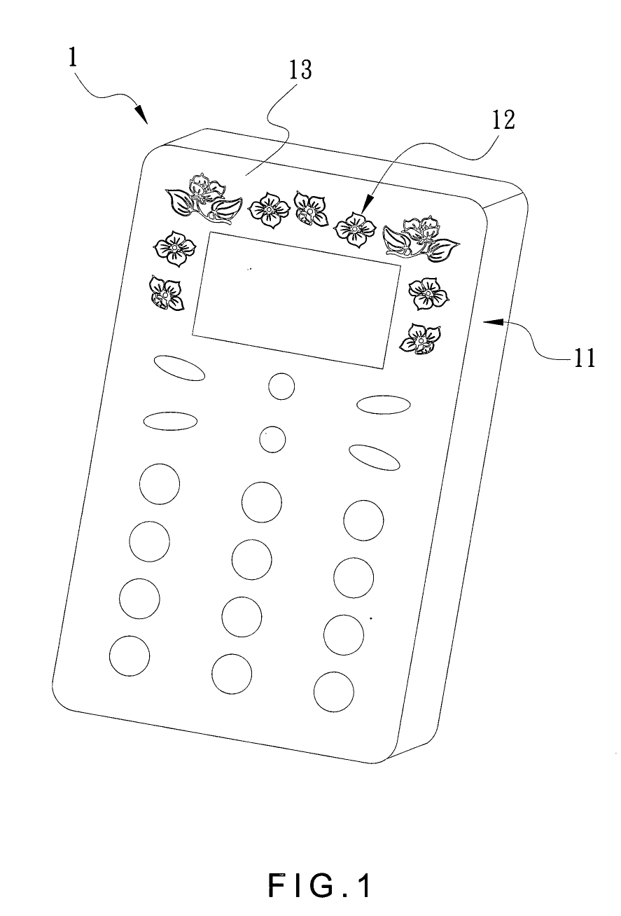

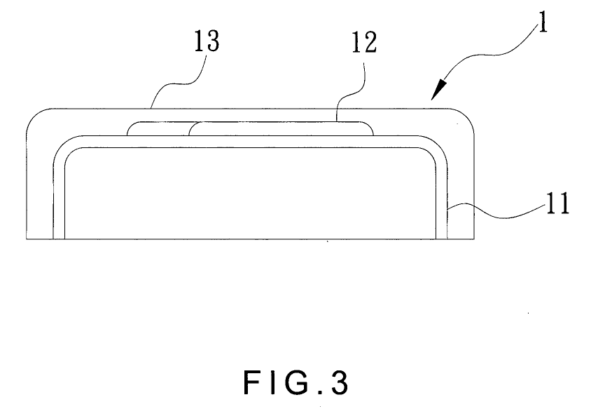

Please refer to FIG. 1 to FIG. 5, which are a perspective view, an explosive view and a sectional view showing a first preferred embodiment and perspective views showing a second and a third preferred embodiments according to the present invention. As shown in the figures, the present invention is a skin having an enameled metal structure for a mobile device, comprising a metal base layer 11, an image area 12 and a coating layer 13, where a mobile device skin 10 is prevented scrape and corrosion and China-chic beauty and feel are obtained with ease of cleaning and good heat conductivity.

The image area 12 is adhered on a surface of the metal base layer 11, where the image area 12 is flat or three-dimensionally (3D) hollowed-out.

The coating layer 13 is covered on the metal base layer 11 and the image area 12, where the coating layer 13 is made of a glass material and a metal oxide; the glass material is mixed with a borate or a silicate; and, the borate has boron oxide above 25 percents (%) after a reduction.

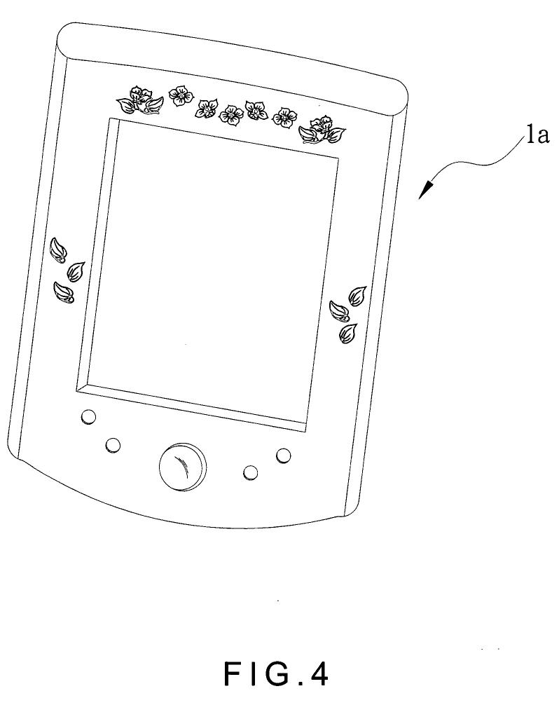

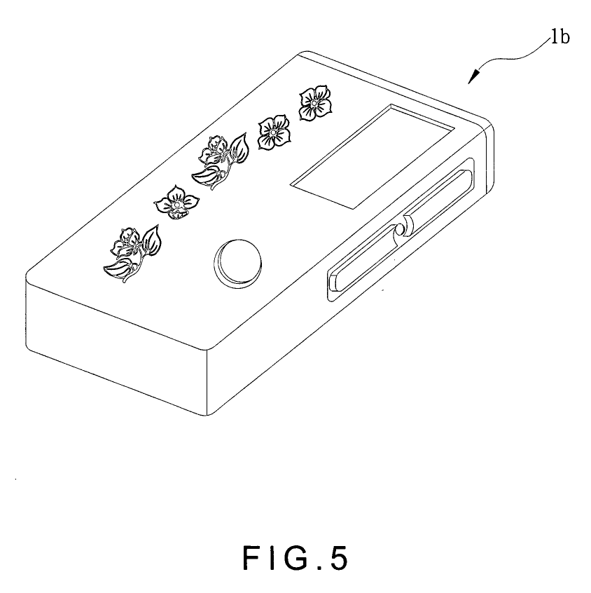

On fabricating the present invention, the metal base layer 11 is formed into a shape to be covered as a mobile device skin. Then the image area 12 is hollowed out with a copper wire or a wire of other metal; and the image area 12 is burnt at 900 Celsius degrees (° C.) to be firmly welded on the metal base layer 11. Then the glass material and the metal oxide are coated on the metal base layer 11 and the image area 22, and are filled into the hollowed-out image area 12; and then are burnt at 750° C. to 800° C. to form a coating layer 13 above the metal base layer 11 and the image are a 12. In the end, a polish is done to the coating layer 13 as required. Therein, the image area 12 is formed through punching, laser etching, chemical etching or metal-wire welding; and, the mobile device is a mobile phone, a personal data assistant (PDA) 1a (as shown in FIG. 4) or an MP3 player 1b (as shown in FIG. 5). Thus, a skin having an enameled metal structure for a mobile device is obtained.

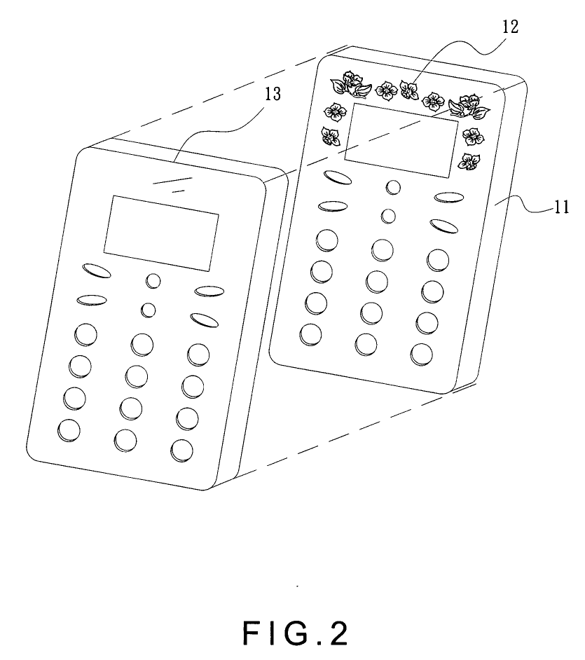

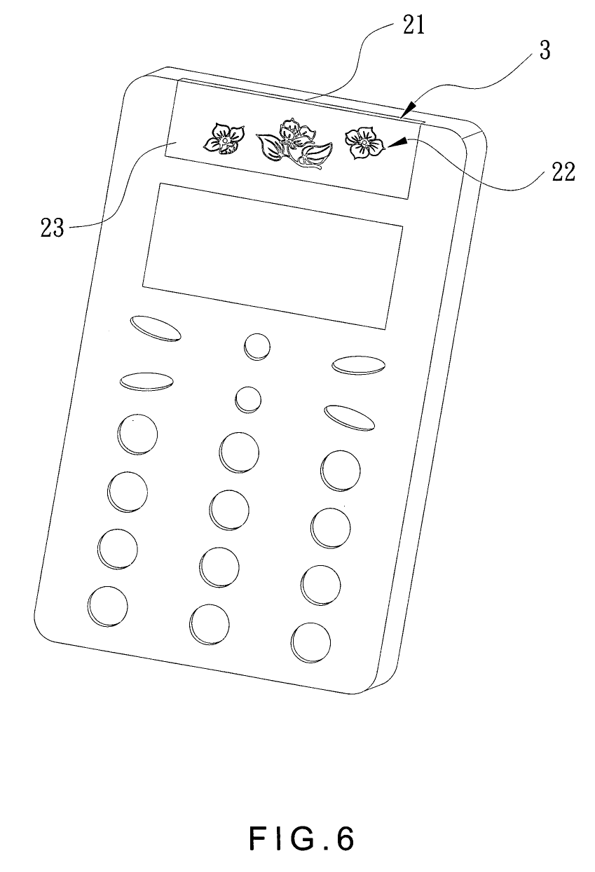

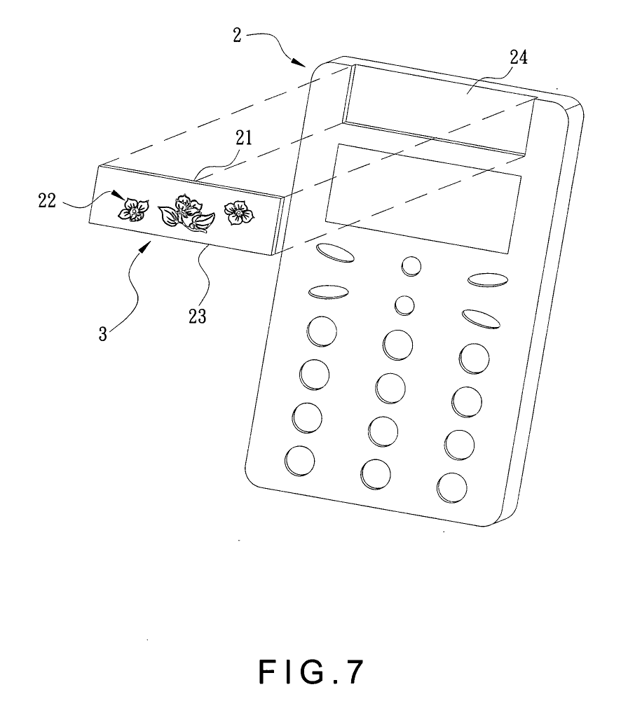

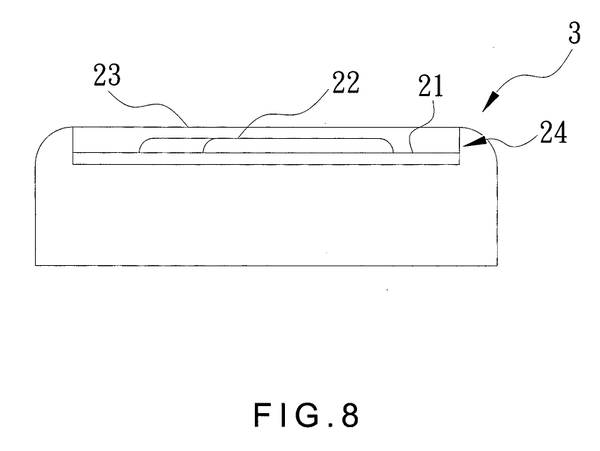

Please refer to FIG. 2 to FIG. 10, which are a perspective view, an explosive view and a sectional view showing a fourth preferred embodiment and perspective views showing a fifth and a sixth preferred embodiments. As shown in the figures, the present invention is a skin having an enameled metal structure for a mobile device, comprising a shell 2 and an image unit 3, where a mobile device skin is prevented from being scraped or corroded and China-chic beauty a n d feel are obtained with ease of cleaning.

The shell 2 is made of plastics; and, the shell 2 has a sunk area 24 on a surface.

The image unit 3 is put in the sunk area 24. The image unit 3 comprises a metal base layer 21; an image area 22 deposed on a surface of the metal base layer 21; and a coating layer 23 covered on the metal base layer 21 and the image area 22. There in, the image area 22 is flat or 3 D hollowed-out; the coating layer 23 is made of a glass material and a metal oxide; the glass material is obtained by mixing with a borate or a silicate; and, the borate has boron oxide above 25% after a reduction.

When fabricating the present invention, the shell 2 and the image unit 3 are separately made. On making the shell 2, the shell 2 is formed into a shape as a skin of a mobile device, like a mobile phone 1; and has a sunk area 24. On making the image unit 3, the metal base layer 21 is formed into the shape of the sunk area 24 at first. Then, the image area 22 is hollowed out with a copper wire or a wire of other metal; and the image are a 32 is burnt at 900° C. to be firmly welded on the metal base layer 21. Then the glass material and the metal oxide are coated over in the sunk area 24 and is filled into the hollowed-out image are a 22 and are burnt at 750° C. to 800° C. to form a coating layer 23 above the metal base layer 21 and the image area 22. In the end, a polish is done as required. Therein, the image area 22 is formed through punching, laser etching, chemical etching or metal-wire welding.

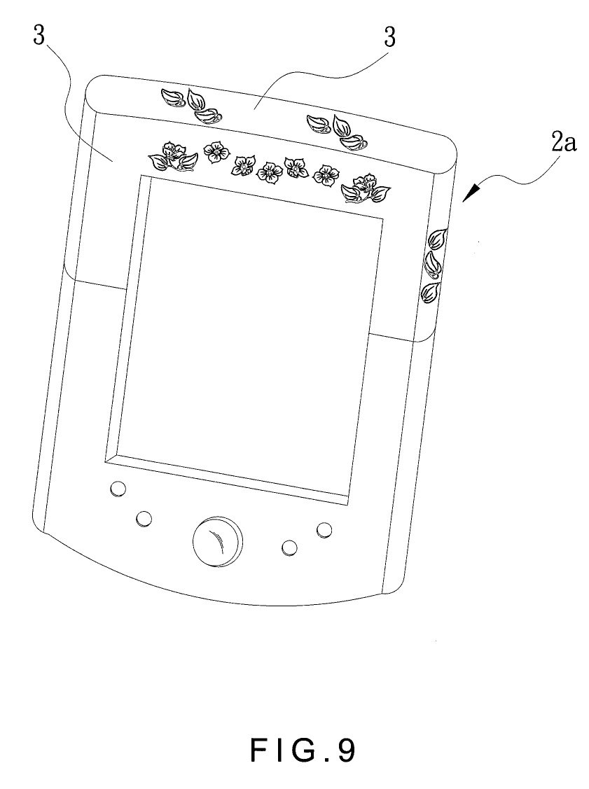

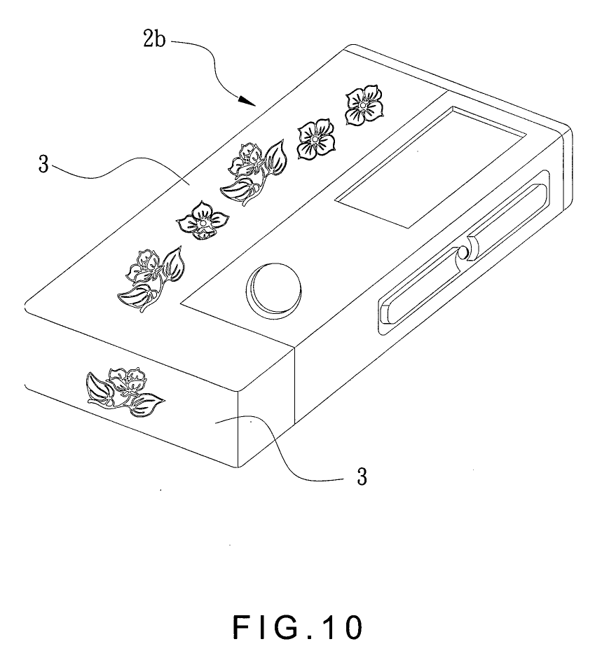

After the shell 2 and the image unit 3 are made, the image unit 3 is adhered to the shell 2 in the sunk are a 24. Thus, a skin having an enameled metal structure for a mobile device is obtained, where the mobile device is a mobile phone, a personal data assistant (PDA) 2a (as shown in FIG. 9) or an MP3 player 2b (as shown in FIG. 10).

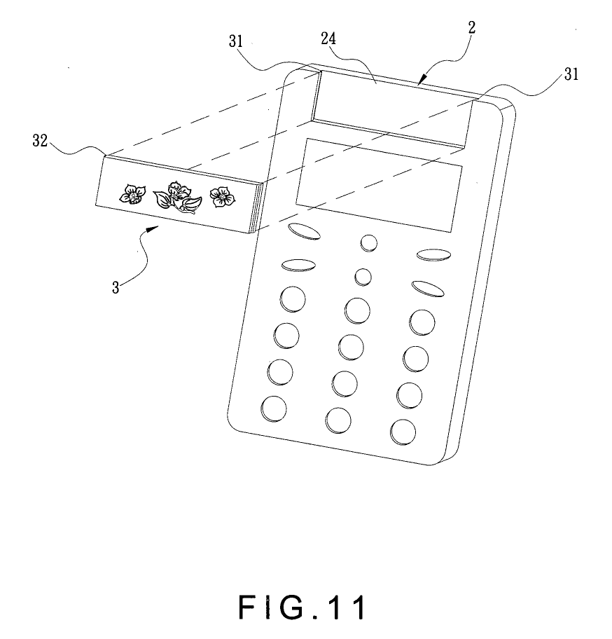

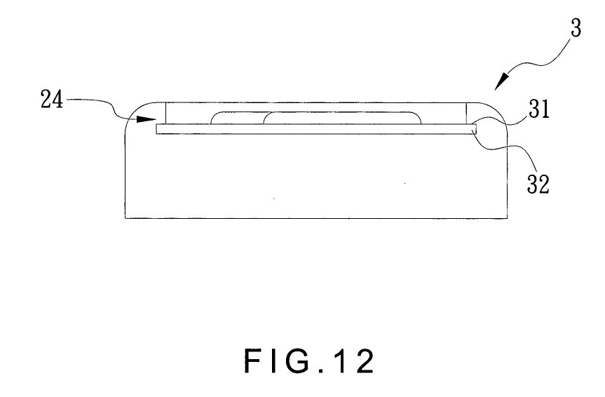

Please refer to FIG. 11 and FIG. 12, which are an explosive and a sectional views showing a seventh preferred embodiment. As shown in the figures, a sunk area 24 of a shell 2 has a concave 31 around on a border wall of the sunk area 24 to be locked with a convex 32 around on a border wall of an image unit 3. Hence, the image unit 3 is locked in the sunk area 24 of the shell 2 by the concave 31 and the convex 32 to obtain a skin having an enameled metal structure for a mobile device.

To sum up, the present invention is a skin having an enameled metal structure for a mobile device, where a mobile device skin is prevented from scrape or corrosion; the mobile device has a good heat conductivity for a required operation performance; and China-chic beauty and feel are obtained with ease of cleaning.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A skin having an enameled metal structure for a mobile device, comprising:
a metal base layer;
an image area, said image are a being deposed on a surface of said metal base layer; and
a coating layer, said coating layer being covered on said metal base layer and said image are a,
wherein said metal base layer, said image area and said coating layer are altogether covered on a mobile device as a skin.

2. The skin according to claim 1,
wherein said mobile device is selected from a group consisting of a mobile phone, a personal data assistant (PDA) and an MP3 player.

3. The skin according to claim 1,
wherein said image area is flat.

4. The skin according to claim 1,
wherein said image are a is three-dimensionally (3D) hollowed-out.

5. The skin according to claim 3,
wherein said image are a is obtained through a method selected from a group consisting of punching, laser etching, chemical etching and metal-wire welding.

6. The skin according to claim 3,
wherein said coating layer is made of a glass material and a metal oxide.

7. The skin according to claim 6,
wherein said glass material of said coating layer is obtained by mixing with a salt selected from a group consisting of a borate and a silicate; and
wherein said borate has boron oxide above 25 percents (%) after a reduction.

8. A skin having an enameled metal structure for a mobile device, comprising:
a shell, said shell having a sunk area on a surface of said shell; and
an image unit, said image unit being deposed in said sunk area, said image unit comprising:
a metal base layer;
an image area, said image area being deposed on a surface of said metal base layer; and
a coating layer, said coating layer being covered on said metal base layer and said image are a,
wherein said shell together with said image unit is deposed on a mobile device.

9. The skin according to claim 8,
wherein said image area is flat.

10. The skin according to claim 8,
wherein said image area is three-dimensionally (3D) hollowed-out.

11. The skin according to claim 10,
wherein said image are a is obtained through a method selected from a group consisting of punching, laser etching, chemical etching and metal-wire welding.

12. The skin according to claim 8,
wherein said coating layer is made of a glass material and a metal oxide.

13. The skin according to claim 12,
wherein said glass material of said coating layer is obtained by mixing with a salt selected from a group consisting of a borate and a silicate; and
wherein said borate has boron oxide above 25% after a reduction.

14. The skin according to claim 8,
wherein said mobile device is selected from a group consisting of a mobile phone, a personal data assistant (PDA) and an M P3 player.

15. The skin according to claim 8,
wherein said shell is made of plastics.

16. The skin according to claim 8,
wherein said sunk are a has a con cave around on a border wall of said sunk area;
wherein said image area has a convex around on a border wall of said image area; and
wherein said sunk area is mutually locked with said image are a with said concave and said convex.

17. The skin according to claim 8,
wherein said image unit is adhered in said sunk area.
